(19) United States
(12) Patent Application Publication
(10) Pub. No.: US 2006/0209526 A1
(43) Pub. Date: Sep. 21, 2006

(54) Light diffusion plate

(76) Inventor: Masahiro Miyauchi, Kanagawa (JP)

Correspondence Address: STAAS & HALSEY LLP, SUITE 700, 1201 NEW YORK AVENUE, N.W., WASHINGTON, DC, 20005, US

(21) Appl. No.: 10/551,472

(22) PCT Filed: Mar. 29, 2004
(86) PCT No.: PCT/JP04/04423

§ 371 Date: Sep. 30, 2005

(30) Foreign Application Priority Data
Apr. 2, 2003 (JP) 2003-99325

(51) Int. Cl. G01D 11/28

(52) U.S. Cl. 362/29

(57) ABSTRACT

This invention provides a light diffusion plate including: a light transmitting thermoplastic resin; and a light diffusing agent, wherein the light diffusing agent is contained in an amount of 0.2 to 10% by weight with respect to the total weight of the light diffusion plate, wherein a degree of brilliancy of at least one surface of the light diffusion plate is from 20 to 70%. This invention enables to provide a light diffusion plate to be used in a direct type backlight device, which is capable of realizing brightness higher than that achieved by conventional light diffusion plates.

### FIELD OF THE INVENTION

This invention relates to a light diffusion plate to be used in a direct type backlight device.

### BACKGROUND ART

Liquid crystal televisions have attracted attention as a home-use television of 21st century both domestically and internationally in recent years, and it is expected that a demand therefor continues growing in future.

The liquid crystal is not a light emitting device such as a cathode ray tube used in conventional televisions, and it is necessary to dispose a flat light source device called a backlight device behind the liquid crystal.

There are broadly two types of backlight devices. One of them is a so-called edge light type or a side light type backlight device, which has a linear light source, ordinarily a cold cathode tube, disposed beside an optical waveguide. The other is a direct type backlight device wherein a light diffusion sheet called light diffusion plate is disposed in front of a linear light source.

The edge light type backlight device is widely used for displays of a personal computer screens and a notebook type personal computer as well as for car navigation display screens.

The direct type backlight device has widely been used for the reasons of a simple structure and brightness, but the edge light type backlight device has grubbed the market share from the direct type backlight device since the direct type backlight device is too thick to meet the demand of reducing the thickness and uses a lot of electricity for plural light sources.

However, since liquid crystal televisions today require brightness as is the case with the cathode ray tube, the direct type backlight device which realizes high brightness due to its structure of directly transmitting light from the light source is attracting attention again. Particularly, use of the direct type backlight device in large screen such as liquid crystal televisions having over 20 inches is rapidly increasing.

The direct type backlight device is schematically shown in FIG. 1.

In the direct type backlight device, a light scattering functional sheet called a light diffusion plate is disposed in front of a linear light source in order to scatter light of the linear light source, and plural optical films having a light condensing function and a polarizing function are laminated in order to emit light effectively.

The light diffusion plate is used for transmitting and scattering light; erasing a so-called lamp image that is a phenomenon that a shape of the linear light source, particularly its linear outline is shown through; and decreasing and uniformizing irregularity in brightness on a screen. Whereas, when the light diffusion property of the light diffusion plate excessively functionate, the light to be transmitted is weakened to darken the screen, which is problematic. The light diffusion plate has heretofore been required to achieve high transmittance property and high diffusion property which are conflicting optical properties.

Also, it has been considered important to refine irregularity on a surface of the light diffusion plate in order to prevent the high diffusion and the lamp image of linear light source. The irregularity on surface is represented as a degree of brilliancy. The surface is smooth as a mirror when a value of the degree of brilliancy is high, while the surface has fine irregularity and reduced in reflection when the degree of brilliancy is low. That is, it has been considered that the high diffusion property is achieved when the degree of brilliancy is low, and methods of reducing the degree of brilliancy have been developed. In fact, the degree of brilliancy of the surface of the conventional light diffusion plates is ordinarily 10% or less, and a non-reflecting light diffusion plate having a fine surface of degree of brilliancy of 1% or 0%, which is the same as the degree of brilliancy of a paper, has been used as the light diffusion plate for the direct type backlight (see Patent Documents 1 to 3, for example).

The above described technologies have realized an increase in brightness of the direct type backlight device to be about twice as that of the edge light type backlight device using an optical waveguide; however, since peak brightness of the direct type backlight device is still lower than that of the cathode ray tube, there is a demand for a further improvement in brightness.

[Patent Document 1] JP 1-172801 A

[Patent Document 2] JP 2-194058 A

[Patent Document 3] JP 11-5241 A

### DISCLOSURE OF THE INVENTION

An object of this invention is to provide a light diffusion plate realizing high brightness for a direct type backlight device.

Though it has been considered that brightness of a surface of a light diffusion plate is increased by lowering a degree of brilliancy of the surface to refine the surface, the present inventors have found that the brightness is largely improved by increasing the degree of brilliancy contrary to the conventional idea. With this finding, the present invention is accomplished.

An object of this invention is achieved by producing a light diffusion plate and a direct type backlight device described below.

1. A light diffusion plate comprising: a light transmitting thermoplastic resin; and a light diffusing agent, wherein the light diffusing agent is contained in an amount of 0.2 to 10% by weight with respect to the total weight of the light diffusion plate, wherein a degree of brilliancy of at least one surface of the light diffusion plate is from 20 to 70%.

2. The light diffusion plate according to item 1, which comprises: a base material layer and; a coating resin layer formed on at least one surface of the base material layer, wherein the base material layer and the coating resin layer each comprises the light transmitting thermoplastic resin and the light diffusing agent.

3. The light diffusion plate according to item 2, wherein an amount of the light diffusing agent contained in the coating resin layer is 1 to 10% by weight with respect to a weight of the coating resin.

4. The light diffusion plate according to item 2, wherein an average particle diameter of the light diffusing agent contained in the coating resin layer is 5 to 30 μm.

5. The light diffusion plate according to item 2, wherein a thickness of the coating resin layer is 20 to 200 μm.

6. A direct type backlight device comprising, in this order: a plurality of linear light sources; the light diffusion plate according to items 1 to 5; and an optical film, wherein a degree of brilliancy of at least a surface of the light diffusion, which contacts with the optical film plate, is from 20 to 70%.

### BRIEF DESCRIPTION OF THE DRAWINGS

FIG. 1 is a drawing showing a direct type backlight device using a light diffusion plate of this invention.

In the drag, reference number 1 denotes a liquid crystal panel, 2 denotes an optical film, 3 denotes a light diffusion plate, 4 denotes a linear light source (cold cathode tube), 5 denotes a reflection plate, and 6 denotes a housing.

### BEST MODE FOR CARRYING OUT THE INVENTION

Hereinafter, this invention will be described in detail.

The direct type backlight device is a flat light source device used at the back of a liquid crystal television and a liquid crystal monitor. The flat light source device can broadly be divided into two types of the edge light type and direct type, as described in the foregoing, and this invention will be applicable to the direct type backlight device.

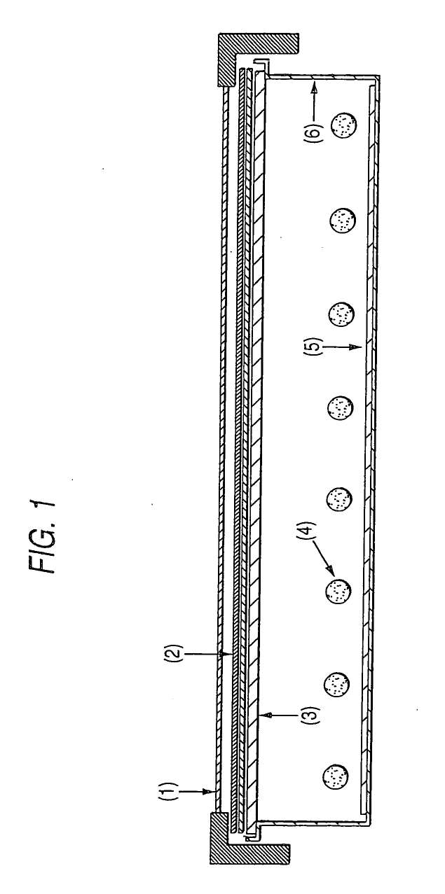

The direct type backlight devices in general have a linear light source, a light diffusion plate for scattering light, and an optical film for condensing and polarizing the light scattered by the light diffusion plate, which are assembled in this order as shown in FIG. 1. A liquid crystal panel is disposed at a light emission side of the optical film to be used as a television or a monitor. On a backside of the linear light source, i.e., at a position opposed to the light diffusion plate, a reflection plate or a reflection film is disposed for the purpose of enhancing a light usability.

The linear light source is a linearly shaped light source such as a fluorescent tube, and a cold cathode tube is ordinarily used as the backlight device for liquid crystal television. A plurality of the linear light sources is used in the direct type backlight device, and the linear light source is frequently bent to be used as a U-shaped tube or a block C-shape in order to reduce the number of components.

Examples of the optical film to be disposed adjacent to the light diffusion plate include a so-called diffusion film, a prism film, a reflection type polarizing film, a viewing angle adjustment film, and the like, and these films are ordinarily used in combination. For instance, a combination of two sheets of the prism film and a reflection type polarizing film; a combination of a diffusion film, a prism film, and a reflection type polarizing film; and the like are possible. Also, an ITO film may be used for shielding electromagnetic wave.

The diffusion plate of this invention is a resin plate made from a light transmitting thermoplastic resin and having a thickness of 0.5 to 5 mm, preferably 1 to 4 mm, and the light transmitting thermoplastic resin contains a light diffusing agent in order to impart light diffusion property and to adjust light transmittance. Examples of the light transmitting thermoplastic resin include an acryl based resin, a styrene based resin, a methyl methacrylate/styrene copolymer resin (MS resin), a polycarbonate based resin, an olefin based resin.

Examples of the light diffusing agent to be contained in the light transmitting thermoplastic resin include silicone based crosslinked particles, acryl based crosslinked particles, styrene based crosslinked particles, methyl methacrylate/styrene copolymer based crosslinked particles (MS based crosslinked particles), calcium carbonate, barium sulfate, aluminum hydroxide, titanium oxide, talc, glass beads. Among the above light diffusing agents, the silicone based crosslinked particles, the acryl based crosslinked particles, the styrene based crosslinked particles, the MS based crosslinked particles, the calcium carbonate, and the talc are preferred since they impart high transmittance and high diffusion property. A refractive index of the light diffusing agent is preferably from 1.40 to 2.40. The above listed light diffusing agents may be used alone or in combination. An average particle diameter of the light diffusing agent is preferably 1 to 50 am, and an amount of the light diffusing agent to be contained is 0.2 to 10% by weight, more preferably 0.5 to 5% by weight, with respect to the total weight of the light diffusion plate. Transmittance of the light diffusion plate can be designed at will by changing the content of the light diffusing agent. The transmittance required as a light diffusion plate is normally 40% or more, preferably 50% or more. Transmittance of 80% or less, preferably 70% or less, is required for preventing the linear light source from being shown through. The transmittance is increased with the reduction in light diffusing agent, and the transmittance is reduced with the increase in light diffusing agent.

In addition to the light diffusing agent, various ultraviolet ray absorbers, an antioxidant, a thermostabilizer, a selected wavelength absorber, a colorant, a fluorescent whitener, and/or an antistatic agent may be contained in the light transmitting thermoplastic resin.

The light diffusion plate of this invention can be a single layer plate made from the above-described light transmitting thermoplastic resin, and it is preferable to use a multilayer plate obtained by laminating a coating resin layer on at least one surface of the single layer plate (base material layer) as the light diffusion plate. It is possible to apply the description of the light diffusion plate made above to details of the base material layer. Note that, in the case where the light diffusion plate has the multilayer structure, a total amount of the light diffusing agent contained in the coating resin layer and the light diffusing agent contained in the base material layer resin must be in the range of 0.2 to 12% by weight with respect to the weight of the light diffusion plate. The resin used for the base material layer and the resin used for the coating layer may be the same or different. For instance, a resin having a high heat resistance may be used for the base material layer, while a resin having a low heat resistance and excellent coating formability is used for the coating layer. Also, a resin having a low water absorption rate may be used for the coating layer, while a resin having a low water absorption rate or a resin having a great strength may be used for the base material. Thus, various resin combinations are possible.

Types of the light diffusing agents to be contained in the light transmitting thermoplastic resin of this invention may be the same or different depending on the base material layer and the coating layer. In the case of the multilayer, a light diffusing agent for increasing the light scattering property may used for the base material layer, and a light diffusing agent different from that used for the base material layer may be used for the coating layer in order to control the degree of brilliancy which will be described later in this specification.

Of course, the coating layer may be one layer or may be constituted of plural layers for plural functions. The coating layer may be formed on one surface of the base material layer, and the number of layers on one surface may be different from the number of layers on the other surface.

As a method for producing the light diffusion plate of this invention, ordinary thermoplastic resin production process such as casting method, extrusion method, and coextrusion method may be employed as it is.

The casting method is a method of molding a thermoplastic resin into a plate-like shape by polymerizing and fixing the thermoplastic resin inside a die assembly, usually between glass plates or stainless steel plates.

The extrusion method is a method of molding a thermoplastic resin into a plate-like shape by heat melting the thermoplastic resin inside an extruder and then extruding the resin from a die having a sheet-like sleeve followed by passing the resin through polishing rollers.

The coextrusion method is the simplest method for producing multilayer. Plural extruders are used for laminating extrusion from a lamination die such as a feed block die and a multi manifold die for laminating plural melt resin layer streams, and the extruded resin streams are passed through polishing rollers to be molded into a plate-like shape.

Of course, a film may be laminated on the thus-obtained resin plate or coating and painting may be performed on the thus-obtained resin plate.

Irregularity is formed on at least one surface of the light diffusion plate of this invention. The reason for the formation of irregularity is the prevention of the linear light source from being shown through due to the increased light scattering effect described above, i.e., the prevention of lamp image; however, the irregularity on the surface also serves to prevent close contact with the optical film disposed adjacent to the light diffusion plate. When the surface of the light diffusion plate is smooth, the light diffusion plate surface and a backface of the optical film disposed on the light diffusion plate adhere to each other due to static electricity so that an interference pattern is generated due to light interference caused by very narrow gap and a difference between refractive indexes. The interference pattern must be avoided since it is a serious defect in appearance of liquid crystal panel constituted of fine cells.

It has been considered that the irregularity on the surface of the light diffusion plate is preferably as fine as possible in view of the prevention of lamp image of the linear light source. That is, as the surface irregularity is reduced to approach to non-reflection, the light scattering on the surface is increased to prevent the linear light source to be shown through.

Though a surface irregularity of a resin plate is usually quantified as a surface roughness, a surface irregularity of the resin plate, i.e., smoothness, is represented by a degree of brilliancy in this invention. The degree of brilliancy is defined in JIS K6900 as a degree of approaching to the absolute optical smoothness of a surface in terms of a capability of reflecting light. It is defined that the surface is smooth when the degree of brilliancy is high, whereas the surface irregularity is reduced to approach to non-reflection with a reduction in degree of brilliancy.

It has been considered that the degree of brilliancy of the surface of the light diffusion plate should be as low as possible in view of the prevention of lamp image of the linear light source. More specifically, the linear light source is undesirably shown through when the degree of brilliancy exceeds 70%, and degree of brilliancy of conventional and popular light diffusion plates is less than 10%. Recently, light diffusion plates with a very fine surface which is almost a non-reflecting surface having degree of brilliancy of 1% or 0% are available.

However, the present inventors have found that brightness is increased with an increase in the degree of brilliancy of the light diffusion plate surface contrary to the orientation of conventional development.

In this invention, degree of brilliancy of at least one surface of the light diffusion plate is from 20 to 70%, more preferably from 30 to 70%, still more preferably from 30 to 60%. The brightness is as low as that of the conventional light diffusion plates when the degree of brilliancy is less than 20%. Whereas, when the degree of brilliancy exceeds 70%, although the brightness is high, the light scattering property is so weak as to showing through the linear light source to cause a problem in appearance.

Also, the present inventors have found that the light diffusion plate with high degree of brilliancy enables a color tone to be whiter and brighter when mounted on a direct type backlight device. Particularly, a light emitting surface becomes visually black due to shadows of the fine surface irregularity when the degree of brilliancy is less than 20%, whereas the light emitting surface is visually tinted with yellow when the degree of brilliancy exceeds 70% due to the interference on the linear light source.

The reason why the degree of brilliancy can change brightness is considered as follows.

The light emitted from the linear light source is scattered in the light diffusion plate as it passes through the light diffusion plate and then is made incident to the optical film disposed on the light diffusion plate. The light incident surface of the optical film is ordinarily smooth and not only the transmitted light but also reflected light exist at the light incident surface. The light reflected by the optical film returns to the light diffusion plate, and, when the degree of brilliancy of the light diffusion plate surface is low, i.e., when the surface is almost non-reflecting with fine irregularity formed thereon, the light reflected by the optical film and returned to the light diffusion plate is scattered on the light diffusion plate surface.

When the surface is high in degree of brilliancy, i.e., when the surface is almost smooth, as in this invention, the light returned to the light diffusion plate after being reflected by the optical film is reflected by the light diffusion plate surface again to be sent back to the optical film. Thus, it is possible to effectively reuse the light to increase the brightness though the light has been scattered on the light diffusion plate surface. The surface facing to the optical film is the surface adjacent to the optical film. In this invention, both surfaces of the light diffusion plate do not necessarily have the above described degree of brilliancy, and it is satisfactory when at least the surface contacting with the optical film has the degree of brilliancy of from 20 to 70%.

Though it has been possible to ignore the reflected light from the optical film in applications which do not expected to achieve high brightness, such as liquid crystal monitors, this invention has revealed that it is necessary to effectively reuse the reflected light in applications which require high brightness, such as liquid crystal television, though an amount of the reflected light is very small.

There are several methods of forming irregularity on the light diffusion plate surface. The light diffusing agent contained in the light diffusion plate serves to form irregularity on the light diffusion plate surface, and, for the purpose of forming finer irregularity, it is possible to employ: a method of transferring an uneven surface of a die formed by etching or cutting on a resin plate surface during resin plate production process; a method of forming irregularity on a film by the use of a diffusion agent by coating a UV cure coating composition or a thermosetting coating composition containing 0.1 to 30 parts by weight of the diffusion agent such as an acryl based crosslinked particles or a silicone based crosslinked particles and curing the coating composition; a method of attaching a so-called emboss film made from an acryl based resin, a polycarbonate based resin, or the like, on which irregularity is formed by the above methods; or the like.

In the case of the multilayer plate, it is unnecessary to form the irregularity on the base material layer, and the irregularity is formed only on the coating layer which is the uppermost surface. For instance, it is possible to form fine irregularity by using a large amount of a light diffusing agent for forming the uppermost coating layer.

There are several methods for adjusting the degree of brilliancy. In the case of mechanically forming the irregularity, it is possible to adjust the degree of brilliancy by using a die having a coarse irregularity or by changing a pressure for transcription. In the case of forming irregularity by the light diffusing agent, it is possible to adjust the degree of brilliancy by changing an amount or a particle size of the light diffusing agent.

It is preferable to use a multilayer plate which can be made highly functional and has a structure that a coating layer resin and a base material layer resin are laminated as the light diffusion plate of this invention, and it is preferable to control the degree of brilliancy by using a large amount of light diffusing agent for the coating layer resin and forming the irregularity by collecting the light diffusing agent.

The light diffusing agent contained in the coating layer resin may be the same as or different from the light diffusing agent contained in the base material layer, and examples of the light diffusing agent include the silicone based crosslinked particles, the acryl based crosslinked particles, the styrene based crosslinked particles, the methyl methacrylate/styrene copolymer based crosslinked particles (MS based crosslinked particles), the calcium carbonate, the barium sulfate, the aluminum hydroxide, the titanium oxide, talc, glass beads as described above. Among the above light diffusing agents, it is preferable to use the silicone based crosslinked particles, the acrylic crosslinked particles, the styrene based crosslinked particles, the MS based crosslinked particles, the calcium carbonate, and the talc.

An average particle diameter of the light diffusing agent contained in the coating layer resin is preferably 5 to 30 am, more preferably 7 to 20 μm. The degree of brilliancy is increased to weaken the light scattering property to cause that the linear light source is undesirably shown through when the average particle diameter is less than 5 μm. Whereas, the degree of brilliancy is reduced to reduce the brightness when the average particle diameter exceeds 30 μm to the contrary.

An amount of the light diffusing agent contained in the coating layer resin is preferably 1 to 10% by weight, more preferably 2 to 9% by weight with respect to a weight of the coating layer resin. The degree of brilliancy is increased to weaken the light scattering property to cause that the linear light source is undesirably shown through when the content of the light diffusing agent in the coating layer resin is less than 1% by weight. Whereas, the degree of brilliancy is reduced to cause that the brightness is undesirably reduced when exceeding 10% by weight.

A total amount of the light diffusing agent contained in the coating layer resin and the light diffusing agent contained in the base material layer resin must be 0.2 to 10% by weight with respect to a total weight of the light diffusion plate. Since a thickness of the coating layer is less than the plate thickness of the light diffusion plate, a proportion of the light diffusing agent in the overall light diffusion plate is relatively small even when a large amount of the light diffusing agent is used for the coating layer resin.

The thickness of the coating layer is preferably 20 to 200 μm, more preferably 30 to 18 μm. The brilliancy is reduced to cause that the brightness is undesirably reduced when the coating layer thickness is less than 20 μm. The degree of brilliancy is increased to reduce light scattering property to cause that the linear light source is undesirably shown through when the coating layer thickness exceeds 200 μm.

The coextrusion method described above is preferably employed for forming the multilayer plate, and irregularity on the surface is solidified when the plate is passed through polishing rollers and cooled. The number of polishing rollers are usually 3 to 6, and, when a nip line pressure of each of the rollers is low, the light diffusing agent in the coating layer is in a state of floating on the surface to increase degree of brilliancy of the surface. When the nip line pressure is increased, the light diffusing agent in the coating layer is forced in the coating layer resin, so that the surface becomes smoother to reduce the degree of brilliancy. A preferred nip line pressure is about 1 to 30 kgf/cm.

### EXAMPLES

This invention will be described based on examples.

A flat light source device used in evaluation is as follows.

Four cold cathode tubes (manufactured by Stanley Electric Co., Ltd.; type: KTCZ26 KPJD) each having a diameter of 3 mm and a length of 200 mm were placed in parallel to one another at an interval of 10 mm at a position distant from a reflection plate by 1 mm to be used as a linear light source. The light diffusion plate of this invention was disposed about 15 mm above the linear light source. A diffusion film (manufactured by Tsujiden Co., Ltd.; type: D121), a prism film (manufactured by Sumitomo 3M Ltd.; type: BEF2), and a reflection type polarizing film (manufactured by Sumitomo 3M Limited; type: DBEF-D) were placed on the light diffusion plate in this order as optical films. A current of 14 V, 0.5 A was supplied to the cold cathode tubes by using a direct stabilized power source to allow the four cold cathode tubes to emit light. Thus, the flat light source device was obtained.

The evaluation was conducted as follows.

Brightness was measured by directly reading a central portion of a light emitting surface of the flat light source device with a brightness meter (manufactured by Topcon Corporation; type: M-7 Fast). The measurement was conducted with a distance between the brightness meter and the light diffusion plate being set to about 50 cm.

As degree of brilliancy of a surface of the light diffusion plate, 60 degree mirror degree of brilliancy was measured in accordance with JIS K7105 and using a degree of brilliancy meter (manufactured by Horiba, Ltd.; type: IG-310).

Transmittance of the light diffusion plate was measured in accordance with JIS K7105 and by using a haze meter (manufactured by Nippon Denshoku; type: 1001DP).

Appearance was observed visually in the flat light source device, and good/no good judgment was made. As used herein, no good means that the lamp image wherein the linear light source was shown through or emergence of the linear defects on the light diffusion plate surface as stripes on the light emitting surface was observed.

Color tone was evaluated by visually observing a color tone of the light emitting surface in the flat light source device, and good/no good judgment was made. As used herein, good means that the light emitting surface was visually white and bright, whereas no good means that the light emitting surface was tinted with yellow due to interference with the linear light source or the light emitting surface was darkened due to shadows of the irregularity on the surface.

### Example 1

A base material layer resin (A) was prepared by adding as a diffusing agent 1.01 parts by weight of silicone based crosslinked beads [manufactured by GE Toshiba Silicones; trade name: TOSPEARL 120 (registered trademark)] having an average particle diameter of 2 μm to 100 parts by weight of an acrylic resin [manufactured by Asahi Kasei Corporation; trade name: DELPET LP-1 (registered trademark)].

A coating layer resin (B) was prepared by adding as a diffusing agent 5.26 parts by weight of a talc [manufactured by Nippon Talc Co., Ltd.; trade name: NTX (registered trademark)] having an average particle diameter of 15 μm to 100 parts by weight of an acrylic resin [manufactured by Asahi Kasei Corporation; trade name: DELPET LP-1 (registered trademark)].

A light diffusion plate having the base material layer (A) and the coating resin layers (b) laminated on the both side of the base material layer (A) was prepared by using a laminated sheet extruder (manufactured by Plabor Co., Ltd.) having a feed block die, a polishing roller, and two extruders (each manufactured by Pla Giken Co., Ltd.; product type: PG) each having a screw diameter of 60 mm and 25 mm. An extruder temperature was set to 260° C.; a die temperature was set to 250° C.; a polishing roller temperature was set to 100° C.; and a polishing roller nip line pressure was set to 20 kgf/cm. A thickness of the coating layer resin (B) was controlled in accordance with a ratio of an amount of the extruded base material layer resin (A), and the coextrusion was so performed as to achieve the thickness of about 30μ on each of the surfaces. A thickness of the light diffusion plate was controlled to be 2 mm by adjusting the extruded amount of the base material layer resin (A) and a gap between the polishing rollers.

A weight of the light diffusing agent contained in the thus-obtained light diffusion plate was 1.12% by weight with respect to a weight of the overall light diffusion plate, and the degree of brilliancy of a surface of the light diffusion plate, which was measured in accordance with JIS K7105, corresponded to 40%.

Brightness was measured by placing the light diffusion plate in the flat light source device described in the foregoing, and the detected brightness was 6,600 cd/m². The result is shown in Table 1 together with Comparative Examples.

TABLE 1

| | Total | Degree | | | |
|---|---|---|---|---|---|
| | Light | of | | | |
| | Trans- | Bril- | | Ap- | Color |
| | mittance | liancy | Brightness | pearance | Tone |
| Example 1 | 65% | 40% | 6,600 cd/m² | Good | Good |
| Example 2 | 65% | 30% | 6,500 cd/m² | Good | Good |
| Example 3 | 65% | 20% | 6,400 cd/m² | Good | Good |
| Example 4 | 65% | 60% | 6,800 cd/m² | Good | Good |
| Example 5 | 66% | 70% | 7,000 cd/m² | Good | Good |
| Example 6 | 65% | 50% | 6,700 cd/m² | Good | Good |
| Comparative | 64% | 8% | 6,000 cd/m² | Good | No good: |
| Example 1 | | | | | black |
| Comparative | 64% | 1% | 5,900 cd/m² | Good | No good: |
| Example 2 | | | | | black |
| Comparative | 66% | 80% | 7,300 cd/m² | No good: | No good: |
| Example 3 | | | | lamp | yellow |
| | | | | image | |

### Comparative Example 1

A light diffusion plate was prepared in the same manner as in Example 1 except for changing the amount of talc contained in the coating layer resin (B) to 17.65 parts by weight.

A weight of the light diffusing agent contained in the light diffusion plate of this Comparative Example corresponded to 1.42% by weight with respect to a weight of the overall light diffusion plate, and degree of brilliancy of a surface of the light diffusion plate was 8% which is almost non-reflective.

Brightness was measured by placing the light diffusion plate in the flat light source device in the same manner as in Example 1, and the detected brightness was 6,000 cd/m². The brightness is surprisingly lower than Example 1 by 600 cd, i.e., about 10% lower than Example 1.

### Example 2

A light diffusion plate was prepared in the same manner as in Example 1 except for changing the amount of talc contained in the coating layer resin (B) to 8.70 parts by weight. A weight of the light diffusing agent contained in the light diffusion plate of this Example corresponded to 1.21% by weight with respect to a weight of the overall light diffusion plate. The result is shown in Table 1.

### Example 3

A light diffusion plate was prepared in the same manner as in Example 1 except for changing the amount of talc contained in the coating layer resin (B) to 11.11 parts by weight. A weight of the light diffusing agent contained in the light diffusion plate of this Example corresponded to 1.27% by weight with respect to a weight of the overall light diffusion plate. The result is shown in Table 1.

### Example 4

A light diffusion plate was prepared in the same manner as in Example 1 except for changing the amount of talc contained in the coating layer resin (B) to 2.04 parts by weight. A weight of the light diffusing agent contained in the light diffusion plate of this Example corresponded to 1.03% by weight with respect to a weight of the overall light diffusion plate. The result is shown in Table 1.

### Example 5

A light diffusion plate was prepared in the same manner as in Example 1 except for changing the amount of talc contained in the coating layer resin (B) to 1.01 parts by weight. A weight of the light diffusing agent contained in the light diffusion plate of this Example corresponded to 1.00% by weight with respect to a weight of the overall light diffusion plate. The result is shown in Table 1.

### Example 6

A light diffusion plate was prepared in the same manner as in Example 1 except for changing the coating layer resin (B) to 100 parts by weight of a methyl methacrylate/styrene copolymer resin, i.e., an MS resin [manufactured by Nippon Steel Chemical Group; trade name: ESTYRENE (registered trademark)] and changing the amount of the talc having an average particle diameter of 15 μm as a diffusing agent to 5.26 parts by weight.

More specifically, this light diffusion plate sample is a different resin lamination multilayer plate of MS resin/acrylic resin/MS resin.

A weight of the light diffusing agent contained in the light diffusion plate of this Example corresponded to 1.21% by weight with respect to a weight of the overall light diffusion plate, and degree of brilliancy of a surface of the light diffusion plate measured in the same manner as in Example 1 was 50%.

Brightness was measured by placing the light diffusion plate in the flat light source device in the same manner as in Example 1, and the detected brightness was 6,700 cd/m². The result is shown in Table 1.

### Comparative Example 2

The light diffusion plate of Example 1 was sandwiched between pressing dies on whose surfaces fine irregularity is formed, and then the fine irregularity was transcript on a surface of the light diffusion plate by heat compression for 3 minutes at 180° C. under a pressure 20 kgf/cm². A weight of the light diffusing agent contained in the light diffusion plate of this Comparative Example corresponded to 1.12% by weight with respect to a weight of the overall light diffusion plate.

Degree of brilliancy of the surface of the thus-obtained light diffusion plate was 1%.

Brightness was measured by placing the light diffusion plate in the flat light source device in the same manner as in Example 1, and the detected brightness was only 5,900 cd/m². The result is shown in Table 1 together with Examples.

### Comparative Example 3

A light diffusion plate was prepared in the same manner as in Example 1 except for changing the amount of talc contained in the coating layer resin (B) to 0.50 part by weight. A weight of the light diffusing agent contained in the light diffusion plate of this Comparative Example corresponded to 0.98% by weight with respect to a weight of the overall light diffusion plate, and degree of brilliancy of a surface of the light diffusion plate was 80%.

Brightness was measured by placing the light diffusion plate in the flat light source device in the same manner as in Example 1, and the detected brightness was 7,300 cd/m². Since the brightness is high, the linear light source is shown through and light interference stripes are observed between the optical films and the light diffusion plate, which is a problem in appearance. The result is shown in Table 1.

### Examples 7 to 9 and Comparative Examples 4 to 5

Light diffusion plates were prepared in the same manner as in Example 1 except for changing the average particle diameter of the light diffusing agent talc contained in the coating layer resin to those shown in Table 2. The result is shown in Table 2 together with Example 1.

TABLE 2

| | Average Particle | | | | | |
|---|---|---|---|---|---|---|
| | Diameter of Light | | | | | |
| | Diffusing Agent | Total | | | | |
| | Contained in Coating | Light | Degree of | | | |
| | Layer Resin | Transmittance | Brilliancy | Brightness | Appearance | Color Tone |
| Example 1 | 15 μm | 65% | 40% | 6,600 cd/m² | Good | Good |
| Example 7 | 5 μm | 66% | 60% | 6,800 cd/m² | Good | Good |
| Example 8 | 20 μm | 65% | 35% | 6,500 cd/m² | Good | Good |
| Example 9 | 30 μm | 64% | 20% | 6,400 cd/m² | Good | Good |
| Comparative | 40 μm | 60% | 15% | 6,100 cd/m² | No good: | No good: |
| Example 4 | | | | | strips | black |
| Comparative | 2 μm | 67% | 80% | 7,300 cd/m² | No good: | No good: |
| Example 5 | | | | | lamp image | yellow |

### Examples 10 to 12 and Comparative Examples 6 to 7

Light diffusion plates were prepared in the same manner as in Example 1 except for changing the thickness of the coating layer to those shown in Table 3. The result is shown in Table 3 together with Example 1.

TABLE 3

| | | Total | | | | |
|---|---|---|---|---|---|---|
| | Coating Layer | Light | Degree of | | | |
| | Thickness | Transmittance | brilliancy | Brightness | Appearance | Color Tone |
| Example 1 | 50 μm | 65% | 40% | 6,600 cd/m² | Good | Good |
| Example 10 | 100 μm | 64% | 45% | 6,300 cd/m² | Good | Good |
| Example 11 | 200 μm | 63% | 60% | 6,000 cd/m² | Good | Good |
| Example 12 | 20 μm | 65% | 30% | 6,500 cd/m² | Good | Good |
| Comparative | 10 μm | 65% | 15% | 6,000 cd/m² | No good: | No good: |
| Example6 | | | | | strips | black |
| Comparative | 500 μm | 60% | 85% | 6,500 cd/m² | No good: | No good: |
| Example7 | | | | | strips | black |

While the present invention has been described in detail and with reference to specific embodiments thereof, it will be apparent to one skilled in the art that various changes and modifications can be made therein without departing from the spirit and scope thereof.

The present application is based on Japanese Patent Application No. 2000-099325 filed on Apr. 2, 2003, and the contents thereof are incorporated herein by reference.

### INDUSTRIAL APPLICABILITY

This invention enables to provide a light diffusion plate to be used in a direct type backlight device, which is capable of realizing brightness higher than that achieved by conventional light diffusion plates.

1. A light diffusion plate comprising:
a light transmitting thermoplastic resin; and
a light diffusing agent,
wherein the light diffusing agent is contained in an amount of 0.2 to 10% by weight with respect to the total weight of the light diffusion plate,
wherein a degree of brilliancy of at least one surface of the light diffusion plate is from 20 to 70%.

2. The light diffusion plate according to claim 1, which comprises:
a base material layer and;
a coating resin layer formed on at least one surface of the base material layer,
wherein the base material layer and the coating resin layer each comprises the light transmitting thermoplastic resin and the light diffusing agent.

3. The light diffusion plate according to claim 2,
wherein an amount of the light diffusing agent contained in the coating resin layer is 1 to 10% by weight with respect to a weight of the coating resin.

4. The light diffusion plate according to claim 2,
wherein an average particle diameter of the light diffusing agent contained in the coating resin layer is 5 to 30 μm.

5. The light diffusion plate according to claim 2,
wherein a thickness of the coating resin layer is 20 to 200 μm.

6. A direct type backlight device comprising, in this order:
a plurality of linear light sources;
the light diffusion plate according to claims 1 to 5; and
an optical film,
wherein a degree of brilliancy of at least a surface of the light diffusion plate, which contacts with the optical film, is from 20 to 70%.
